(19) United States
(12) Patent Application Publication
(10) Pub. No.: US 2005/0108154 A1
(43) Pub. Date: May 19, 2005

(54) Methods and systems for providing a financial instrument

(76) Inventors: Dirk C. McLiesh, Washington, DC (US); Walter H. Blotkamp, Vienna, VA (US); Lori Rose Holmes, Washington, DC (US); Patricia Jane Newcomer-Simmons, Glen Allen, VA (US)

Correspondence Address: Finnegan, Henderson, Farabow,;Garrett & Dunner, L.L.P., 1300 I Street, N.W., Washington, DC, 20005-3315, US

(21) Appl. No.: 10/716,650

(22) Filed: Nov. 19, 2003

(51) Int. Cl. G06F 17/60

(52) U.S. Cl. 705/39

(57) ABSTRACT

Providing, to a consumer having a first financial instrument, a second financial instrument may comprise receiving funds associated with the first financial instrument held with a first institution, the funds having been reduced by a penalty for closing the first financial instrument. Next, the funds may be increased by a first amount based on the reduced funds due to the penalty. Then the increased funds may be transferred the to the second financial instrument.

### TECHNICAL FIELD

The present invention relates to the field of financial investment funds. More particularly, the present invention, in various specific embodiments, involves systems and methods for providing a financial instrument in a way that attracts or retains investors.

### BACKGROUND INFORMATION

Financial institutions, such as banks, are critical to our global economy. A bank's primary function is to put their depositor's money to use by lending it out to others who can then use it to, for example, buy homes, businesses, or send their children to school. When a depositor places money in a bank, the money goes into a large pool along with other depositors' money, and the depositor's account is credited with the amount deposited. When the depositor writes checks or makes withdrawals, that amount is deducted from the account balance. The depositor earns interest on the balance of the account.

In the United States, the amount of money that a bank can lend is directly affected by the reserve requirement set by the Federal Reserve, which currently requires banks to hold 3 to 10 percent of the bank's total deposits in reserve. This amount can be held either in cash at the bank or in the bank's reserve account with the Federal Reserve Bank. Even though a law, such as the Federal Reserve Act, may require banks to keep a certain percentage of their money in reserve, if all depositors came to withdraw their money at the same time, there would not be enough. Consequently, if a bank fails, the depositor's money may be protected up to a certain limit as long as the bank is insured by, for example, the Federal Deposit Insurance Corporation (FDIC).

In performing their function, banks and other financial institutions provide a variety of financial services. Banks, for example, provide loans, issue certificates of deposit (CDs), provide credit card accounts, as well as other financial products. In particular, CDs bear a maturity date, a specified interest rate, and can be issued in various denominations. Technically, a CD is a type of promissory note made by a bank. CDs under $100,000 are called “small CDs” and CDs for more than $100,000 are called “large CDs” or “Jumbo CDs.” Almost all large CDs, as well as some small CDs, are negotiable. Because the money held in a CD is expected to stay on deposit until maturity, a bank may assess a penalty if the money is withdrawn early. Typically, the penalty is three to six month's interest. In addition to other deposits, CDs up to $100,000 may be governmentally insured by the FDIC, for example. While insured deposits may be desirable, many depositors may find a CD's early withdraw penalty problematic.

As stated above, other services provided by financial institutions may include providing credit card services. Generally, a credit card provider pays a merchant for goods or services when the goods or services are provided to the credit card user. The credit card user, however, does not pay the credit card provider for some time after the goods or services are provided. Having enough money to pay merchants prior to receiving payment from the credit card user may be problematic for financial institutions providing credit card services.

Thus, there is a need for improved systems and methods for providing a financial instrument. For instance, there is a need to attract new investors and to hold existing investors with the financial institution offering the financial instrument. Furthermore, there is a need for such improved systems and methods to be based on CDs.

### SUMMARY OF THE INVENTION

In accordance with the current invention, a financial instrument method and system are provided that avoid the problems associated with prior financial instrument methods and systems as discussed herein above.

In one aspect, a method for providing, to a consumer having a first financial instrument, a second financial instrument comprises receiving funds associated with the first financial instrument held with a first institution, the funds having been reduced by a penalty for closing the first financial instrument, increasing the funds by a first amount based on the reduced funds due to the penalty, and transferring the increased funds to the second financial instrument.

In another aspect, a system for providing, to a consumer having a first financial instrument, a second financial instrument comprises a component for receiving funds associated with the first financial instrument held with a first institution, the funds having been reduced by a penalty for closing the first financial instrument, a component for increasing the funds by a first amount based on the reduced funds due to the penalty, and a component for transferring the increased funds to the second financial instrument.

In yet another aspect, a computer-readable medium on which is stored a set of instructions for providing a financial instrument, which when executed perform stages comprising receiving funds associated with the first financial instrument held with a first institution, the funds having been reduced by a penalty for closing the first financial instrument, increasing the funds by a first amount based on the reduced funds due to the penalty, and transferring the increased funds to the second financial instrument.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a flow chart of an exemplary method providing a financial instrument consistent with an embodiment of the present invention;

FIG. 2 is a functional block diagram of an exemplary investment system including an exemplary financial instrument system consistent with an embodiment of the present invention; and

FIG. 3 is a functional block diagram of the exemplary financial instrument system of FIG. 2 consistent with an embodiment of the present invention.

### DETAILED DESCRIPTION

Reference will now be made to various embodiments according to this invention, examples of which are shown in the accompanying drawings and will be obvious from the description of the invention. In the drawings, the same reference numbers represent the same or similar elements in the different drawings whenever possible.

Systems and methods consistent with the present invention relate to the offering of financial instruments. Consistent with an exemplary embodiment, systems and methods of the invention may, for example, receive a consumer's funds associated with an existing financial instrument of another financial institution. The existing financial instrument may, for instance, be a CD. Prior to receiving the funds, the other institution may have reduced the funds due to a penalty for the consumer closing the existing financial instrument. For example, if the financial instrument comprises a CD, the penalty may be assessed for “breaking” the CD or cashing the CD before a pre-agreed term has expired. After receiving the funds, systems and methods consistent with the invention may then increase the funds by a first amount and transfer the increased funds to a new financial instrument. The new financial instrument may also comprise a CD. As described below, exemplary embodiments consistent with the invention may determine the increased amount of the funds based on, for example, penalties incurred in closing the existing financial instrument, such that the consumer may then be more inclined to transfer the funds to the new financial instrument.

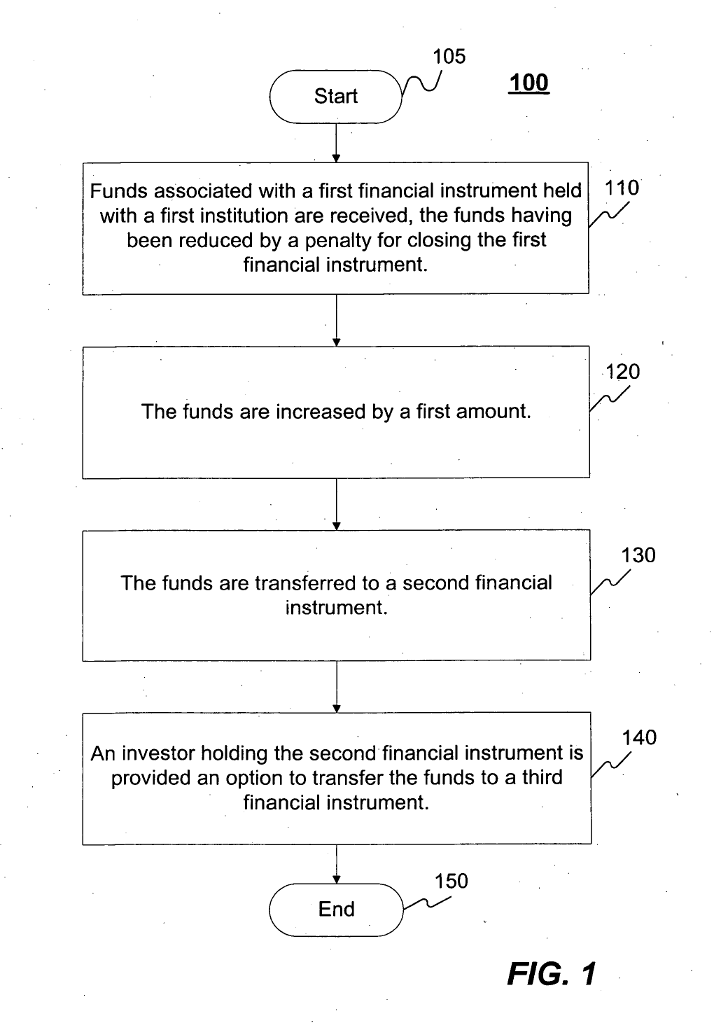

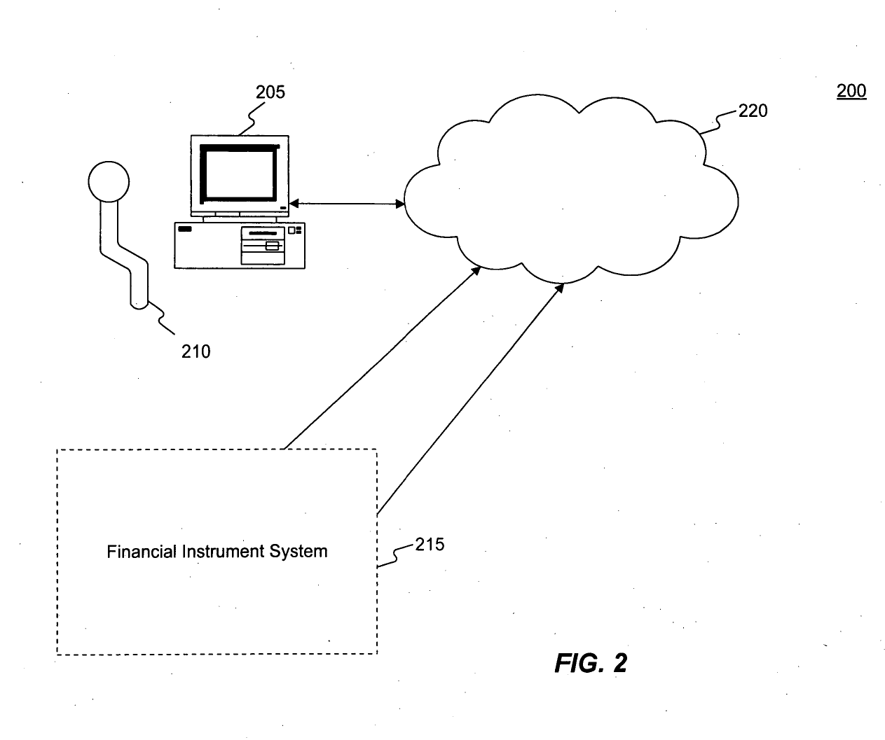

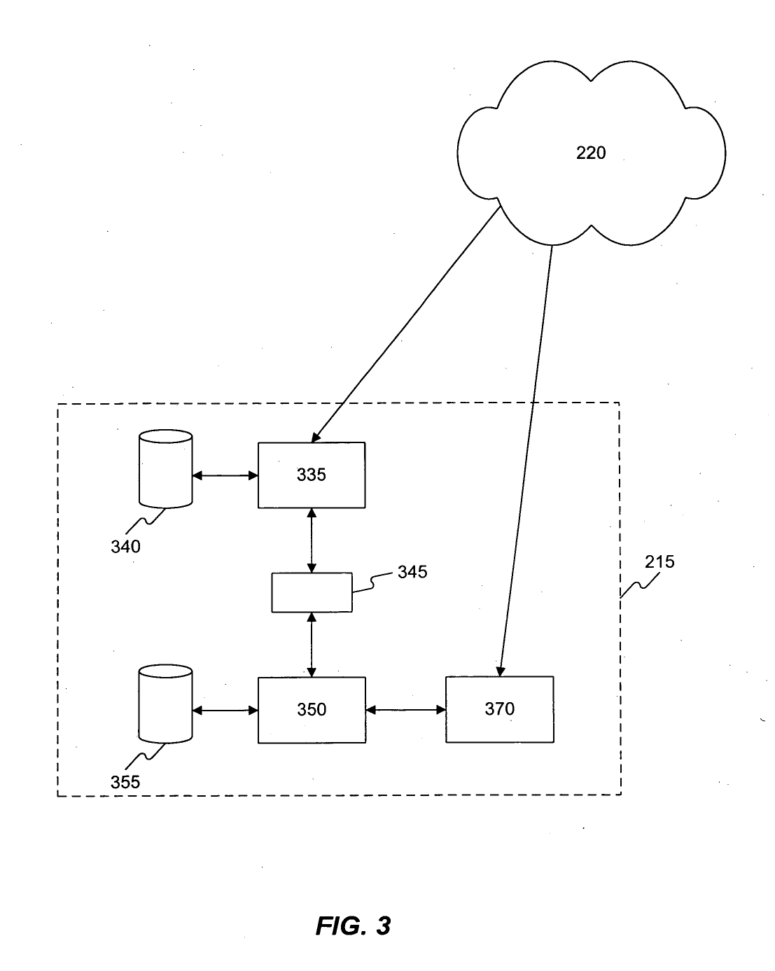

FIG. 1 is a flow chart setting forth the general stages involved in exemplary method 100 for providing a financial instrument. The implementation of the stages of exemplary method 100 in accordance with an exemplary embodiment of the present invention will be described in greater detail below. As described below with respect to FIGS. 2 and 3, the stages of exemplary method 100 may be preformed by a financial instrument system 215.

Exemplary method 100 begins at starting block 105 and proceeds to stage 110 where funds associated with a first financial instrument of a first institution are received. The funds may have been reduced by a penalty for closing the first financial instrument. For example, an investor owning the first financial instrument, a CD with the first institution for example, may wish to liquidate the first financial instrument. In this case, funds resulting from the liquidation may be reduced by the first institution due to an early withdraw penalty previously agreed to by the investor and the first institution. The early withdraw penalty may comprise an amount equal to between three and six months interest earned on the first financial instrument.

From stage 110 where the funds associated with the first financial instrument held with the first institution are received, exemplary method 100 advances to stage 120 where the funds are increased by a first amount. For example, a second financial institution, in an effort to attract the investor and the funds liquidated from the first financial instrument, may offer to increase the funds back to a level prior to the penalty. The amount of increase is not limited to the amount of a penalty and it will be appreciated that there are many other ways to determine the amount of increase for the funds.

Once the funds are increased by the first amount in stage 120, exemplary method 100 advances to stage 130 where the funds are transferred to a second financial instrument. For example, in return for increasing the funds, the investor may invest the funds in a second financial instrument with the second financial institution. Specifically, the consumer, prior to closing the first financial instrument with the first institution, may desire a higher rate of return and subsequently learn that the second financial institution pays a more desirable return. Furthermore, by increasing the funds by the first amount in stage 120, transferring the funds to the second financial instrument may be even more attractive to the consumer.

After the funds are transferred to the second financial instrument in stage 130, exemplary method 100 proceeds to stage 140 where an investor holding the second financial instrument is provided an option to transfer the funds to a third financial instrument. For example, the second financial institution may provide the investor holding the second financial instrument an option to transfer the funds to a third financial instrument managed by the second financial institution. In one exemplary embodiment, method 100 may present this option after a period of time has passed from when the funds were transferred to the second financial instrument. Alternatively, method 100 may present this option after some other events, such as a change in interest rates or based on other account activity. The third financial instrument may have a rate of return greater than the second financial instrument and may be offered in an effort to retain the investor and the investor's funds with the second financial institution. Moreover, the third financial instrument may comprise a CD, for example, and may be selected by the investor or by the second financial institution.

As an alternative, rather than the second financial institution providing the investor holding the second financial instrument an option to transfer the funds to a third financial instrument managed by the second financial institution, the second financial institution may offer to alter the terms of the second financial instrument. For example, the second financial institution may offer a higher interest rate or other more favorable terms. This offer to alter the terms of the second financial instrument may be presented after a period of time has passed from when the funds were transferred to the second financial instrument. In addition, this option may be presented after some other events, such as a change in interest rates or based on other account activity.

With respect to the method of FIG. 1, the first financial instrument, the second financial instrument, and the third financial instrument may comprise, for example, certificates of deposit (CDs), jumbo CDs, promissory notes, or time deposits. The aforementioned financial instruments are exemplary and other financial instruments maybe used. Furthermore, stages 110 to 140 above may be performed by the second financial institution managing the second financial instrument. From stage 140 where the investor holding the second financial instrument is provided an option to transfer the funds to a third financial instrument, exemplary method 100 ends at stage 150.

Consistent with an exemplary embodiment of the present invention, a system for providing a financial instrument may comprise a component for receiving funds associated with a first financial instrument held with a first institution, the funds having been reduced by a penalty for closing the first financial instrument, a component for increasing the funds by a first amount, and a component for transferring the funds to a second financial instrument. Furthermore, an exemplary embodiment of the present invention may include a component for providing an investor holding the second financial instrument an option to transfer the funds to a third financial instrument after a period of time has passed from when the funds were transferred to the second financial instrument, the third financial instrument having a rate of return greater than the second financial instrument, the second financial instrument and the third financial instrument being managed by a second financial institution.

Consistent with an exemplary embodiment of the present invention, the aforementioned components may comprise, be disposed, or implemented within financial instrument system 215, as shown in FIGS. 2 and 3 and described below. Financial instrument system 215 is exemplary and other devices and systems may comprise the aforementioned components and still be consistent with embodiments of the present invention. In addition, financial instrument system 215 may be operated by a financial institution, an enterprise managing the financial instrument, or other entities or enterprises, for example.

FIG. 2, illustrates components of an investment system 200 including a user device 205, financial instrument system 215, and a communication system 220. FIG. 3 illustrates financial instrument system 215 in greater detail. With respect to FIG. 2, user device 205 may comprise a personal computer or other similar microcomputer-based workstation. User device may be used, for example, to transfer any data or other communications between the customer and a financial institution, for example the second financial institution. The data transferred may comprise, for example, any data used to perform method 100 as described above. User device 205 may comprise any type of computer operating environment such as hand-held devices, multiprocessor systems, microprocessor-based or programmable sender electronics, minicomputers, mainframe computers, and the like. User device 205 may also be practiced in distributed computing environments where tasks are performed by remote processing devices. Furthermore, user device 205 may comprise a mobile terminal such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and user device 205 may comprise other systems or devices.

A PDA is a handheld computer that serves as an organizer for personal information. It generally includes at least a name and address database, to-do list and note taker. PDAs are typically pen-based and use a stylus (“pen”) to tap selections on menus and to enter printed characters. The unit may also include a small on-screen keyboard which is tapped with the pen. Data may be synchronized between the PDA and a desktop computer through a cable or wireless transmissions. WAP is a standard for providing cellular phones, pagers and other handheld devices with secure access to e-mail and text-based Web pages. It provides a complete environment for wireless applications that includes a wireless counterpart of TCP/IP and a framework for telephony integration such as call control and phone book access. Wireless Markup Language (WML), which is a streamlined version of HTML for small screen displays, is featured in WAP. WAP uses WMLScript, a compact language that runs in limited memory, and supports handheld input methods such as keypads and voice recognition. In addition, WAP is independent of the air interface and runs over all the major wireless networks. Moreover, it is also device independent, requiring only a minimum functionality in the unit so that it can be used with many different phones and handheld devices.

User device 205 may be located in a home, an office, a store, a retail center kiosk, an office of a financial institution, an office of an enterprise managing the financial investment fund, or any location wherein it may be operated. Moreover, user device 205 may be operated by user 210 that may comprise a consumer, an investor, a technician, a financial advisor, a sales consultant, a sales person, or any other person. It can be appreciated that user device 205 may be located at a variety of places and operated by a variety of people.

Communication system 220 may comprise, for example, a local area network (LAN) or a wide area network (WAN). Such networking environments are commonplace in offices, enterprise-wide computer networks, intranets, and the Internet, for example. When a LAN is used as communication system 220, user device 205 and elements of financial instrument system 215 may be connected to communication system 220 through a network interface located at each of the respective user device 205 and elements of financial instrument system 215. When a WAN networking environment is utilized as communication system 220, user device 205 and elements of financial instrument system 215 typically include an internal or external modem (not shown) or other means for establishing communications over the WAN, such as the Internet.

In addition to utilizing a wire line communications system as communication system 220, a wireless communications system, or a combination of wire line and wireless may be utilized as communication system 220 in order to, for example, exchange web pages via the internet, exchange e-mails via the Internet, or for utilizing other communications channels. Wireless can be defined as radio transmission via the airwaves, however, those skilled in the art will appreciate that various other communication techniques can be used to provide wireless transmission including infrared line of sight, cellular, microwave, satellite, packet radio and spread spectrum radio. User device 205 and elements of financial instrument system 215 in the wireless environment can be any mobile terminal such as a cellular phone, personal digital assistant (PDA), intelligent pager, portable computer, hand held computer, or any device capable of receiving wireless data. Wireless data may include, but is not limited to, paging, text messaging, e-mail, Internet access and other specialized data applications specifically excluding or including voice transmission.

In utilizing communication system 220, data sent over communication system 220 may be encrypted to insure data security. When encrypting, the data may be converted into a secret code for transmission over a public network. The original file, or “plaintext,” may be converted into a coded equivalent called “ciphertext” via an encryption algorithm executed, for example, on user device 205 or on elements of financial instrument system 215. The ciphertext is decoded (decrypted) at a receiving end and turned back into plaintext.

The encryption algorithm may use a key, which may be a binary number that is typically from 40 to 128 bits in length. The greater the number of bits in the key (cipher strength), the more possible key combinations and the longer it would take to break the code. The data is encrypted, or “locked,” by combining the bits in the key mathematically with the data bits. At the receiving end, the key is used to “unlock” the code and restore the original data.

There are several cryptographic methods that may be suitable for use with system 200. For example, system 200 may use the Data Encryption Standard (DES) which used a secret key. In DES, both sender and receiver use the same key to encrypt and decrypt. This is a faster method, but transmitting the secret key to the recipient in the first place is not secure. Another method is public-key cryptography, such as the Rivest-Shamir-Adleman (RSA) highly-secure cryptography method by RSA Data Security, Inc., Redwood City, Calif., (www.rsa.com). RSA uses a two-part concept with both a private and a public key. The private key is kept by the owner; the public key is published. Each recipient has a private key that is kept secret and a public key that is published for everyone. The sender looks up the recipient's public key and uses it to encrypt the message. The recipient uses the private key to decrypt the message. Owners never have a need to transmit their private keys to anyone in order to have their messages decrypted, thus the private keys are not in transit and are not vulnerable.

Public key cryptography software marketed under the name Pretty Good Privacy (PGP) from Pretty Good Privacy, Inc., (PGP) of San Mateo, Calif., (www.pgp.com) may also be utilized with system 200. PGP is based on the RSA cryptographic method. A version for personal, non-business use is available on various Internet hosts. While PGP may be used to encrypt data transmitted over communication system 220, it can be appreciated that many other types of encryption algorithms, methods and schemes may be employed.

In system 200, data may be transmitted by methods and processes other than, or in combination with communication system 220. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

FIG. 3 illustrates a block diagram of exemplary financial instrument system 215. Referring to FIG. 3, exemplary financial instrument system 215 may comprise a first server front end 335 with its associated first server front end database 340, a first server back end 350 with its associated first server back end database 355, and a simple mail transfer protocol (SMTP) server 370. This particular architecture of financial instrument system 215 is exemplary, and many other types of systems or architectures may be employed to implement financial instrument system 215.

In exemplary financial instrument system 215, first server front end 335 is separated from first server back end 350 by a first server firewall 345. One function of first server front end 335 is to provide an interface via communication system 220 between user device 205 and financial instrument system 215. The function of the SMTP server 370 is to provide, for example, an e-mail interface via communication system 220 between user device 205 and financial instrument system 215.

First server front end 335 and first server back end 350 may comprise a personal computer or other similar microcomputer-based workstations. First server front end 335 and first server back end 350 may comprise any type of computer operating environment such as hand-held devices, multiprocessor systems, microprocessor-based or programmable sender electronics, minicomputers, mainframe computers, and the like. First server front end 335 and first server back end 350 may also be practiced in distributed computing environments where tasks are performed by remote processing devices. Exemplary embodiments of first server front end 335 may utilize a COMPAQ PROLIANT 1600 server running WINDOWS 2000 and DOMINO Webserver. Similarly, first server back end 350 may be implemented on a COMPAQ PROLIANT 1600 server running NT4 and DOMINO Application Server. And SMTP server 370 may be implemented on a COMPAQ DL 360 running WINDOWS 2000 and DOMINO SMTP Mail Server.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements (not shown) which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for providing, to a consumer having a first financial instrument, a second financial instrument, the method comprising:
receiving funds associated with the first financial instrument held with a first institution, the funds having been reduced by a penalty for closing the first financial instrument;
increasing the funds by a first amount based on the reduced funds due to the penalty; and
transferring the increased funds to the second financial instrument.

2. The method of claim 1, further comprising providing an investor holding the second financial instrument an option to transfer the funds to a third financial instrument based on predetermined account criteria.

3. The method of claim 2, wherein the predetermined account criteria comprises a predetermined period of time.

4. The method of claim 1, further comprising providing an investor holding the second financial instrument an option to change the terms of the second financial instrument based on predetermined account criteria:

5. The method of claim 4, wherein the predetermined account criteria comprises a predetermined period of time.

6. The method of claim 2, wherein the third financial instrument has a rate of return greater than the second financial instrument.

7. The method of claim 2, wherein the second financial instrument and the third financial instrument are managed by a second financial institution.

8. The method of claim 2, wherein at least one of the first financial instrument, the second financial instrument, and the third financial instrument comprise at least one of a certificate of deposit, a jumbo certificate of deposit, a promissory note, and a time deposit.

9. The method of claim 1, wherein at least one of receiving the funds, increasing the funds, and transferring the increased funds further comprises communicating over a network.

10. The method of claim 9, wherein communicating over the network further comprises communicating with a user device on the network, the user device being located in at least one of a home, an office, a store, a retail center kiosk, and an office of a financial institution.

11. The method of claim 1, wherein the penalty is an early withdraw penalty.

12. The method of claim 1, wherein the penalty is an amount equal to between three and six months interest on the first financial instrument.

13. The method of claim 1, wherein a second financial institution managing the second financial instrument implements at least one of receiving the funds associated with the first financial instrument, increasing the funds by the first amount, and transferring the increase funds.

14. A system for providing, to a consumer having a first financial instrument, a second financial instrument, the system comprising:
a component for receiving funds associated with the first financial instrument held with a first institution, the funds having been reduced by a penalty for closing the first financial instrument;
a component for increasing the funds by a first amount based on the reduced funds due to the penalty; and
a component for transferring the increased funds to the second financial instrument.

15. The system of claim 14, further comprising a component for providing an investor holding the second financial instrument an option to transfer the funds to a third financial instrument based on predetermined account criteria.

16. The system of claim 15, wherein the predetermined account criteria comprises a predetermined period of time.

17. The system of claim 14 further comprising a component for providing an investor holding the second financial instrument an option to change the terms of the second financial instrument based on predetermined account criteria.

18. The system of claim 17, wherein the predetermined account criteria comprises a predetermined period of time.

19. The system of claim 15, wherein the third financial instrument has a rate of return greater than the second financial instrument.

20. The system of claim 15, wherein the second financial instrument and the third financial instrument are managed by a second financial institution.

21. The system of claim 15, wherein at least one of the first financial instrument, the second financial instrument, and the third financial instrument comprise at least one of a certificate of deposit, a jumbo certificate of deposit, a promissory note, and a time deposit.

22. The system of claim 14, wherein at least one of the component for receiving the funds, the component for increasing the funds, and the component for transferring the increased funds is further configured for communicating over a network.

23. The system of claim 14, wherein at least one of the component for receiving the funds, the component for increasing the funds, and the component for transferring the increased funds is further configured for communicating over a network with a user device on the network, the user device being located in at least one of a home, an office, a store, a retail center kiosk, and an office of a financial institution.

24. The system of claim 14, wherein the penalty is an early withdraw penalty.

25. The system of claim 14, wherein the penalty is an amount equal to between three and six months interest on the first financial instrument.

26. The system of claim 14, wherein a second financial institution managing the second financial instrument implements at least one of receiving the funds associated with the first financial instrument, increasing the funds by the first amount, and transferring the increase funds.

27. A computer-readable medium on which is stored a set of instructions for providing a financial instrument, which when executed perform stages comprising:
receiving funds associated with the first financial instrument held with a first institution, the funds having been reduced by a penalty for closing the first financial instrument;
increasing the funds by a first amount based on the reduced funds due to the penalty; and
transferring the increased funds to the second financial instrument.

28. The computer-readable medium of claim 27, further comprising providing an investor holding the second financial instrument an option to transfer the funds to a third financial instrument based on predetermined account criteria.

29. The computer-readable medium of claim 28, wherein the predetermined account criteria comprises a predetermined period of time.

30. The computer-readable medium of claim 27, further comprising providing an investor holding the second financial instrument an option to change the terms of the second financial instrument based on predetermined account criteria.

31. The computer-readable medium of claim 30, wherein the predetermined account criteria comprises a predetermined period of time.

32. The computer-readable medium of claim 28, wherein the third financial instrument has a rate of return greater than the second financial instrument.

33. The computer-readable medium of claim 28, wherein the second financial instrument and the third financial instrument are managed by a second financial institution.

34. The computer-readable medium of claim 28, wherein at least one of the first financial instrument, the second financial instrument, and the third financial instrument comprise at least one of a certificate of deposit, a jumbo certificate of deposit, a promissory note, and a time deposit.

35. The computer-readable medium of claim 27, wherein at least one of receiving the funds, increasing the funds, and transferring the increased funds further comprises communicating over a network.

36. The computer-readable medium of claim 35, wherein communicating over the network further comprises communicating with a user device on the network, the user device being located in at least one of a home, an office, a store, a retail center kiosk, and an office of a financial institution.

37. The computer-readable medium of claim 27, wherein the penalty is an early withdraw penalty.

38. The computer-readable medium of claim 27, wherein the penalty is an amount equal to between three and six months interest on the first financial instrument.

39. The computer-readable medium of claim 27, wherein a second financial institution managing the second financial instrument implements at least one of receiving the funds associated with the first financial instrument, increasing the funds by the first amount, and transferring the increase funds.
